(19) United States
(12) Patent Application Publication
(10) Pub. No.: US 2012/0293331 A1
(43) Pub. Date: Nov. 22, 2012

(54) Display Device Having Watch-Time Reminding Function To Prevent Nearsightedness

(76) Inventor: Zhang-Hang Wu, Fuqing City (CN)

(21) Appl. No.: 13/110,051

(22) Filed: May 18, 2011

(51) Int. Cl. G08B 23/00

(52) U.S. Cl. 340/573.1

(57) ABSTRACT

A display device having a watch-time reminding function includes an input unit, a display unit, a sound output unit and a control unit. A user can use the input unit to set a health watch time or turn on or off the watch-time reminding function. After the watch-time reminding function is turned on, the control unit counts a current watch time and compares the current watch time with the health watch time. When the current watch time reaches the health watch time, the control unit judges that the user spends too much time watching the display device. Accordingly, the control unit controls the display unit to display a reminding image and controls the sound output unit to output a reminding sound so as to remind the user to take a rest or do eye exercise to prevent nearsightedness.

### BACKGROUND OF THE INVENTION

1. Field of the Invention

The present invention relates to a display device and, more particularly, to a display device having a watch-time reminding function to prevent nearsightedness.

2. Description of the Related Art

Today, many people like to surf the internet, play games, learn and work on computers and often unconsciously spend too much time watching monitors of the computers, resulting in easily suffering from nearsightedness or other eye diseases. Accordingly, there is a need for a display device such as a monitor of a computer to remind a user when the user spends too much time watching the display device.

### SUMMARY OF THE INVENTION

According to an aspect of the present invention, a display device having a watch-time reminding function to prevent nearsightedness is provided for reminding a user when the user spends too much time watching the display device. The display device includes an input unit, a display unit, a sound output unit and a control unit. The input unit provides a user to input an instruction to set a health watch time or turn on or off the watch-time reminding function. The display unit displays a reminding image when receiving a reminding signal. The sound output unit outputs a reminding sound when receiving the reminding signal. The control unit is coupled to the input unit, the display unit and the sound output unit. The control unit starts counting a current watch time when receiving the instruction of turning on the watch-time reminding function; the control unit outputs the reminding signal when the current watch time reaches the health watch time; and, the control unit does not output the reminding signal when the current watch time does not reach the health watch time.

In one embodiment, the input unit includes a keypad module. The keypad module includes a plurality of keys. The keys provide the user to press to generate the instruction.

In one embodiment, the input unit includes a remote control receiver module. The remote control receiver module receives a remote control signal to generate the instruction. The remote control signal is generated by the user pressing keys of a remote controller.

In one embodiment, the control unit includes a timer module, a storage module and a control module. The timer module counts the current watch time. The storage module stores the health watch time. The control module is coupled to the timer module and the storage module. The control module controls the timer module to start counting the current watch time and reads the health watch time stored in the storage module when receiving the instruction of turning on the watch-time reminding function; the control module outputs the reminding signal to control the display unit to display the reminding image and controls the sound output unit to output the reminding sound when the current watch time reaches the health watch time; and, the control module does not output the reminding signal when the current watch time does not reach the health watch time.

In one embodiment, the display device includes a monitor, television or all-in-one computer. The sound output unit includes a loudspeaker or beeper. The control module includes a microcontroller. The storage module includes a non-volatile memory.

The present invention introduces the display device having the watch-time reminding function. The user can use the input unit to set the health watch time or turn on or off the watch-time reminding function. After the watch-time reminding function is turned on, the control unit counts the current watch time and compares the current watch time with the health watch time. When the current watch time reaches the health watch time, the control unit judges that the user spends too much time watching the display device. Accordingly, the control unit controls the display unit to display the reminding image and controls the sound output unit to output the reminding sound so as to remind the user to take a rest or do eye exercise to prevent nearsightedness.

### BRIEF DESCRIPTION OF THE DRAWINGS

The foregoing and other features of the disclosure will be apparent and easily understood from a further reading of the specification, claims and by reference to the accompanying drawings in which:

FIG. 1 is a circuit block diagram of a display device having a watch-time reminding function to prevent nearsightedness according to an embodiment of the present invention; and

FIG. 2 is a flowchart of a method for controlling a display device having a watch-time reminding function to prevent nearsightedness according to an embodiment of the present invention.

### DETAILED DESCRIPTION OF THE INVENTION

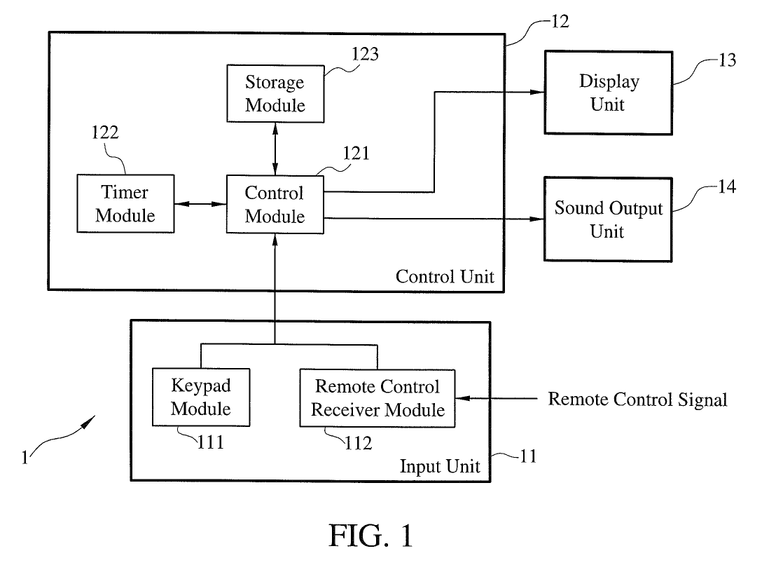

FIG. 1 is a circuit block diagram of a display device having a watch-time reminding function to prevent nearsightedness according to an embodiment of the present invention. Referring to FIG. 1, a display device 1 having a watch-time reminding function to prevent nearsightedness may be a monitor, television, an all-in-one computer, or the like. The display device 1 includes an input unit 11, a control unit 12, a display unit 13 and a sound output unit 14. The control unit 12 is coupled to the input unit 11, the display unit 13 and the sound output unit 14.

The input unit 11 provides a user to input an instruction to set a health watch time or turn on or off the watch-time reminding function. The input unit 11 includes a keypad module 111 and a remote control receiver module 112 which are usually disposed on a front cover of the display device 1. The keypad module 111 includes a plurality of keys. The user presses a specific key of the keys to generate the instruction so as to control the display device 1 to perform a corresponding task, for example turning on or off the power of the display device 1, turning on or off the watch-time reminding function, or setting parameters such as the health watch time, a brightness value or a contrast value. In addition, the user presses a specific key of keys disposed on a remote controller (not shown) to generate a remote control signal. When the remote control receiver module 112 receives the remote control signal, the remote control receiver module 112 decodes the received remote control signal to generate the instruction so as to control the display device 1 to perform a corresponding task.

The control unit 12 includes a control module 121, a timer module 122 and a storage module 123, in which the control module 121 is coupled to the timer module 122 and the storage module 123. The timer module 122 counts a current watch time. The storage module 123, such as a non-volatile memory, stores the user-set parameters such as the health watch time, the brightness value or the contrast value. In one embodiment, the storage module 123 further temporarily stores real-time data such as the current watch time. The control module 121, such as a microcontroller, controls the timer module 122 to start counting the current watch time and reads the health watch time stored in the storage module 123 when receiving the instruction of turning on the watch-time reminding function from the input unit 11. In addition, the control module 121 outputs a reminding signal to control the display unit 13 to display a reminding image and controls the sound output unit 14 to output a reminding sound when the current watch time reaches the health watch time (i.e. the current watch time is not less than the health watch time); otherwise, the control module 121 does not output the reminding signal when the current watch time does not reach the health watch time (i.e. the current watch time is less than the health watch time).

The display unit 13 copes with reminding image information contained in the reminding signal to display the reminding image when receiving the reminding signal, in which the reminding image information can be stored in the storage module 123 beforehand. For example, the reminding image is implemented by employing the on-screen display (OSD) technique to show a reminding message on a displaying content (such as a movie) so as to remind the user to take a rest, or by changing from the displaying content to a multimedia content of eye exercise so as to assist the user in doing eye exercise to relax the user's eyes. The display unit 13 normally displays the content when not receiving the reminding signal.

The sound output unit 14, such as a loudspeaker or beeper, copes with reminding sound information contained in the reminding signal to output the reminding sound when receiving the reminding signal, in which the reminding sound information can be stored in the storage module 123 beforehand. For example, the reminding sound is an alarm voice cooperating with the reminding message showed on the displaying content, or a guiding voice or music cooperating with the multimedia content of eye exercise.

In one embodiment, after the watch-time reminding function of the display device 1 is turned on, when the display device 1 counts the current watch time not to the health watch time (i.e. the current watch time does not reach the health watch time), the display device 1 further employs the OSD technique to keep on showing the reminding message about the current watch time, the health watch time and/or the difference between the current watch time and the health watch time on the corner of the displaying content so that the user can know, at any time, that how long does he/she watch the display device (i.e. corresponding to the current watch time) and how long should he/she stop watching the display device to take a rest (i.e. corresponding to the difference between the current watch time and the health watch time).

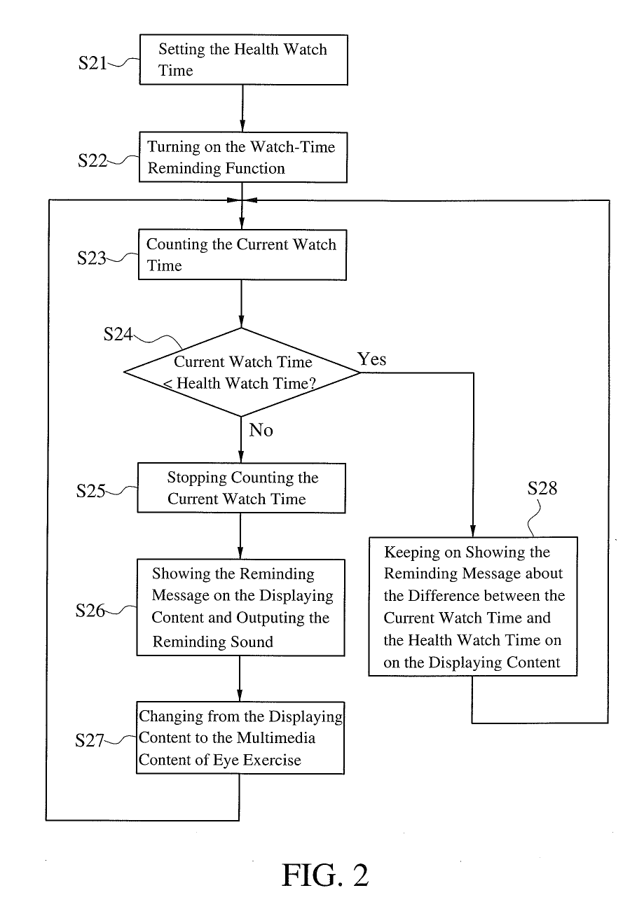

FIG. 2 is a flowchart of a method for controlling a display device having a watch-time reminding function to prevent nearsightedness according to an embodiment of the present invention, in which the display device is, for example, the display device 1 shown in FIG. 1. Referring to FIGS. 1 and 2, at a step S21, the user uses the input unit 11 to set the health watch time (e.g. 45 minutes). The control module 121 stores the user-set health watch time into the storage module 123. At a step S22, the user uses the input unit 11 to turn on the watch-time reminding function of the display device 1. At a step S23, the control module 121 controls the timer module 122 to start counting the current watch time and stores the current watch time into the storage module 123. At a step S24, the control module 121 compares the current watch time with the user-set health watch time.

When the control module 121 judges that the current watch time reaches the health watch time (i.e. the current watch time is not less than the health watch time), it represents that the user spends too much time watching the display device 1, and accordingly, the control module 121 performs a step S25 to stop counting the current watch time and then performs steps S26 and S27 to control the display unit 13 to display the reminding image and control the sound output unit 14 to output the reminding sound so as to remind the user to take a rest or do eye exercise. At the step S26, the control module 121 controls the display unit 13 to employ the OSD technique to show the reminding message (e.g. watch time is too long) on the displaying content and controls the sound output unit 14 to output the reminding sound (e.g. beep). At the step S27, the control module 121 controls the display unit 13 to change from the displaying content to the multimedia content of eye exercise (e.g. a picture, movie, music or game of eye exercise) so as to assist the user in doing eye exercise to relax the user's eyes. Next, the flow of the method goes back to the step S23 to continue performing the watch-time reminding function, and now the control module 121 controls the timer module 122 to restart counting the current watch time.

When the control module 121 judges that the current watch time does not reach the health watch time, it represents that the user does not yet spend too much time watching the display device 1, and accordingly, the control module 121 performs a step S28 to control the display unit 13 to normally display the content and keep on showing the reminding message about the difference between the current watch time and the health watch time on the corner of the displaying content so that the user can know, at any time, that how long should he/she stop watching the display device to take a rest. Next, the flow of the method goes back to the step S23 to continue performing the watch-time reminding function, and now the control module 121 controls the timer module 122 to continue counting the current watch time.

In summary, the present invention introduces the display device having the watch-time reminding function. The user can use the input unit to set the health watch time or turn on or off the watch-time reminding function. After the watch-time reminding function is turned on, the control unit counts the current watch time and compares the current watch time with the health watch time. When the current watch time reaches the health watch time, the control unit judges that the user spends too much time watching the display device. Accordingly, the control unit controls the display unit to display the reminding image and controls the sound output unit to output the reminding sound so as to remind the user to take a rest or do eye exercise to prevent nearsightedness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A display device having a watch-time reminding function to prevent nearsightedness, comprising:
an input unit, for providing a user to input an instruction to set a health watch time or turn on or off the watch-time reminding function;
a display unit, for displaying a reminding image when receiving a reminding signal;
a sound output unit, for outputting a reminding sound when receiving the reminding signal; and
a control unit, coupled to the input unit, the display unit and the sound output unit, for starting counting a current watch time when receiving the instruction of turning on the watch-time reminding function, outputting the reminding signal when the current watch time reaches the health watch time, and not outputting the reminding signal when the current watch time does not reach the health watch time.

2. The display device according to claim 1, wherein the input unit comprises a keypad module comprising a plurality of keys for providing the user to press to generate the instruction.

3. The display device according to claim 1, wherein the input unit comprises a remote control receiver module for receiving a remote control signal to generate the instruction, wherein the remote control signal is generated by the user pressing keys of a remote controller.

4. The display device according to claim 1, wherein the control unit comprises:
a timer module, for counting the current watch time;
a storage module, for storing the health watch time; and
a control module, coupled to the timer module and the storage module, for controlling the timer module to start counting the current watch time and reading the health watch time stored in the storage module when receiving the instruction of turning on the watch-time reminding function, outputting the reminding signal to control the display unit to display the reminding image and control the sound output unit to output the reminding sound when the current watch time reaches the health watch time, and not outputting the reminding signal when the current watch time does not reach the health watch time.

5. The display device according to claim 4, wherein the storage module comprises a non-volatile memory.

6. The display device according to claim 4, wherein the control module comprises a microcontroller.

7. The display device according to claim 1, wherein the display device comprises a monitor.

8. The display device according to claim 1, wherein the display device comprises a television.

9. The display device according to claim 1, wherein the display device comprises an all-in-one computer.

10. The display device according to claim 1, wherein the sound output unit comprises a loudspeaker or beeper.
